(19) United States
(12) Patent Application Publication
(10) Pub. No.: US 2023/0102475 A1
(43) Pub. Date: Mar. 30, 2023

(54) BROKERING SERVICE TO VERIFY ONLINE CLAIMS

(71) Applicant: Cisco Technology, Inc., San Jose, CA (US)

(72) Inventors: Marcelo Yannuzzi, Vufflens-La-Ville (CH); Hervé MUYAL, Gland (CH); Benjamin William RYDER, Lausanne (CH); Jean Andrei DIACONU, Gaillard, (FR)

(21) Appl. No.: 17/483,969

(22) Filed: Sep. 24, 2021

(51) Int. Cl. G06Q 30/00; H04L 9/32; H04L 9/30

(52) U.S. Cl. CPC G06Q 30/018; H04L 9/3218; H04L 9/30; G06Q 2220/00

(57) ABSTRACT

In one embodiment, a brokering service receives, from a requesting device, a request to verify an online claim associated with an online resource. The brokering service identifies, based upon the request, a proving entity for the online claim. The brokering service obtains, from the proving entity, digitally verifiable proof that indicates that the online claim has been securely verified by the proving entity. The brokering service provides the digitally verifiable proof to the requesting device, wherein the digitally verifiable proof causes the requesting device to display an indication that the online claim has been securely verified.

### TECHNICAL FIELD

The present disclosure relates generally to computer networks, and, more particularly, to a brokering service to verify online claims.

### BACKGROUND

It has become common practice for online websites and applications to make a variety of claims or assertions. For instance, an entity might claim on its website that it holds a quality certification granted by the International Organization for Standardization (ISO), that it supplies food that is organic, that it holds a cyber security certification, or the like. While some claims might be true and legitimately displayed online, others might be false and could lead to practices or consequences with negative connotations, for example, in terms of health, safety, or security.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate an example architecture for verifying online claims by a brokering service;

FIG. 4 illustrates an example architecture of a proactive proving monitoring process for discovery of online claims; and

FIG. 5 illustrates an example simplified procedure for verifying online claims by a brokering service.

### DESCRIPTION OF EXAMPLE EMBODIMENTS

Overview

According to one or more embodiments of the disclosure, a brokering service receives, from a requesting device, a request to verify an online claim associated with an online resource. The brokering service identifies, based upon the request, a proving entity for the online claim. The brokering service obtains, from the proving entity, a digitally verifiable proof that indicates that the online claim has been securely verified by the proving entity. The brokering service provides the digitally verifiable proof to the requesting device, wherein the digitally verifiable proof causes the requesting device to display an indication that the online claim has been securely verified.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

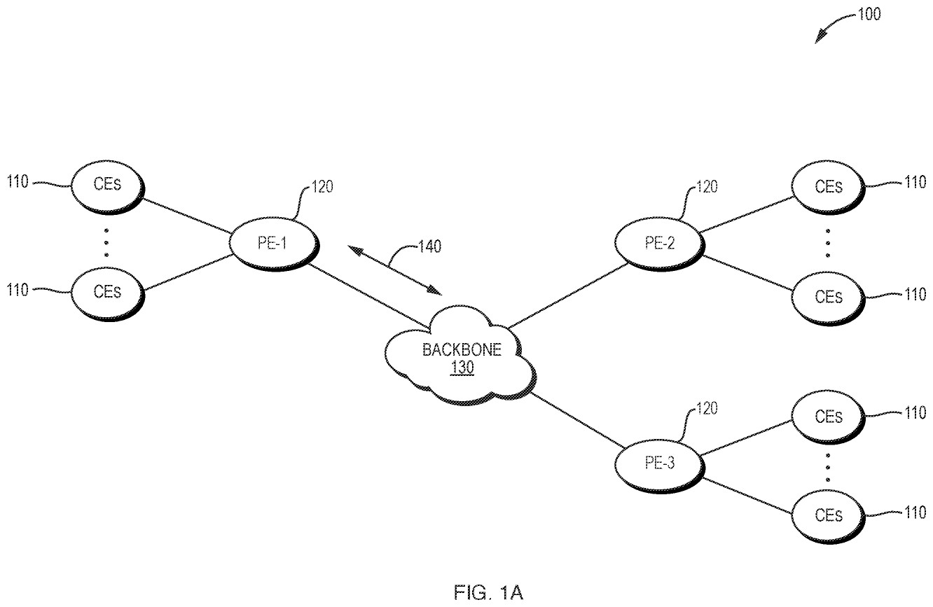

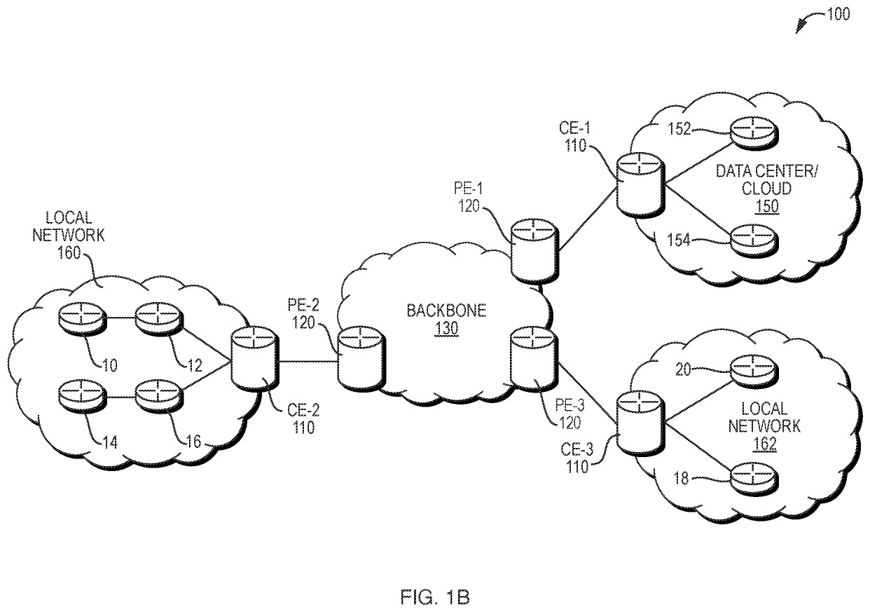

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

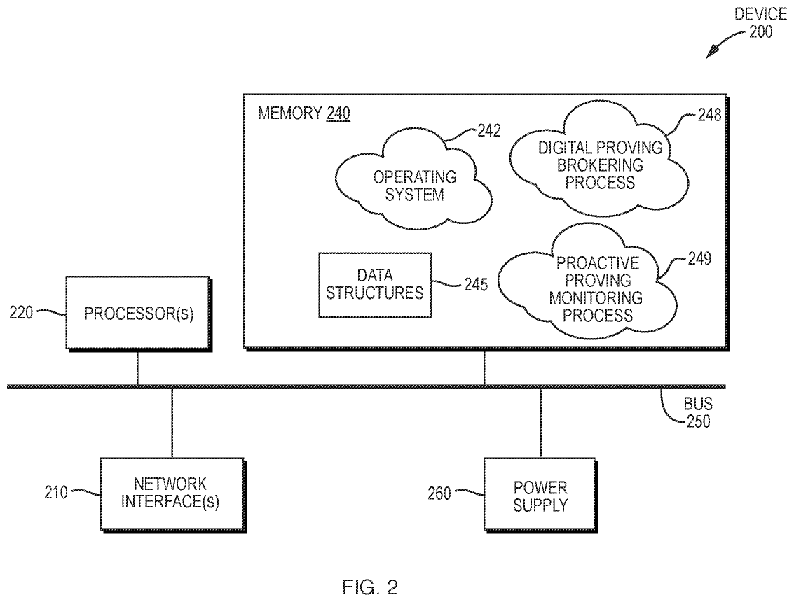

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise digital proving brokering process 248 and proactive proving monitoring process 249, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

As noted above, claims or assertions of different nature regarding products, services, etc. on online websites have become common practice. For instance, an entity (e.g., a website owner like a retailer, service provider, etc.) might claim on its website that it holds a quality certification granted by the International Organization for Standardization (ISO); the food it supplies is “bio” (i.e., organic origin); holds a cyber security certification; has been granted a permit to construct a condo near the shore; etc. While some claims might be true and legitimately displayed online, others might be false and could lead to practices or consequences with negative connotations, for example, in terms of health, safety, or security. Furthermore, the capacity to automatically identify, interpret, then verify claims or assertions lacks any standardization.

Conventionally, the aforementioned claims or assertions are accompanied by logos, banners, digital plaques, etc. that are displayed on a website (or any other online resource) operated by an entity website, where the logos, banners, etc. allegedly embody (and are indicative of) the veracity or truth of the claims or assertions made by the entity. These logos, banners, etc. oftentimes cannot be verified in a digital manner. Indeed, this “verification” process does not entail any form of digital proof, and, instead, it relies on an end user of a website to merely view the logos, banners, etc. with their human eyes then blindly trust an associated claim. In other words, this approach does not provide any means to digitally verify the authenticity of a claim.

In a related pursuit for “verifying” claims, blockchain-based solutions have arisen, including the World Wide Web Consortium's (W3Cs) verifiable credentials, decentralized identifiers (DIDs), decentralized public key infrastructures (DPKIs), as well as distributed ledger technologies (DLTs). Although blockchain-based solutions provide means to handle proofs and verify them, they pose multiple challenges. Different types of online claims or assertions may require substantially different types of proofs and may involve a plethora of siloed private and public blockchains. Each of these varying blockchains rely on different technologies, necessitating the use of different software clients to verify the proofs stored in those blockchains. That is, the holders of the claims require data registries or the like to build trust via the storage of immutable proofs, and they usually depend on the use of digital wallets, data vaults, etc. Another area of difficulty concerns the storage of perpetual proofs (that, for example, would live forever in a third party blockchain). In particular, this is not only inefficient but also undesired in many cases, as it requires trust in the blockchain itself. In other words, reliance on the “holder” of the claim itself retaining a set of verifiable credentials poses challenges vis-à-vis trust and authenticity.

Brokering Service to Verify Online Claims

The techniques herein introduce systems and methods to verify online claims (or assertions) made by entities using a brokering service. In particular, the brokering service may facilitate the request and issuance of ephemeral proofs among claiming entities (e.g., website operators that make claims or assertions about good, services, etc. on online resources), end users at devices that may want to verify online claims (i.e., verifying devices), and entities, institutions, etc. that are capable of proving the veracity and authenticity of the claims. The brokering service may perform automated verifications of online claims in a trustworthy, secure, dynamic, and fully automated manner. Specifically, a prover (i.e., entities, institutions, etc. that are capable of proving the veracity and authenticity of the claims) is ultimately capable of verifying, using ephemeral proofs, claims of interest that are made by the claiming entities, where end users (at verifier devices) may dynamically request such verification. The ephemeral proofs may be issued by the prover on-demand, and they may be directly sent to an end user verifier device in real-time. In some embodiments, the ephemeral proofs may be issued by the brokering service on-demand, on its own. That is, the claiming entity is bypassed, as it intervenes neither in the communication of the ephemeral proof, nor in the display of any form of a logo, banner, digital plaque, etc. that may act as proof. In other words, the techniques herein may be implemented irrespective of whether a claiming entity displays conventional logos, banners, etc. along their claims or assertions. At the end user verifier device, because ephemeral proofs may automatically be verified using the techniques herein, the end user may no longer need to base its trust in claims using only human eye verification.

It is contemplated that digital proof and verification can be handled by the brokering service in a secure and automated manner (e.g., without any human intervention and in the “background”), without needing to display results in a human readable manner.

In addition, due to the nature of the brokering service's location, the techniques herein have no requirement for established trust between the claiming entity and the end user verifying devices. There is also no reliance on systems based on the above-described blockchain. That is, rather than issuing perpetual proofs, such as the ones supported by blockchains, the brokering service enables exchange of ephemeral proofs that facilitate automated verification(s) of online claim(s). The techniques described herein, accordingly, neither depend nor rely on third party blockchains, thereby eliminating the need for multiple blockchain client devices (which, as described above, presents many challenges).

In addition, the techniques herein may further enable multi-modal observation and discovery of online claims or assertions, along with proactive filtering and verification of these claims or assertions. Notably, the techniques herein may be configured to discover and/or expose claims or assertions that are relevant to an organization (e.g., claims that might represent a risk or a threat to the organization itself, entities and/or individuals that they may represent, or that the organization may represent, etc.). In other words, the techniques herein may be tailored for organizations that lack means to digitally support and verify claim(s) made about it. For instance, an organization or entity, such as an industrial certification authority (e.g., ISO), may discover web sites that claim to have a valid certification, where in fact such certification may have expired or, even worse, may have never been granted.

Illustratively, the techniques described herein may be performed by hardware, software, and/or firmware, such as in accordance with digital proving brokering process 248 and/or proactive proving monitoring process 249, which may include computer executable instructions executed by the processor 220 (or independent processor of interfaces 210) to perform functions relating to the techniques described herein.

Specifically, according to various embodiments, a brokering service receives, from a requesting device, a request to verify an online claim associated with an online resource. The brokering service identifies, based upon the request, a proving entity for the online claim. The brokering service obtains, from the proving entity, a digitally verifiable proof that indicates that the online claim has been securely verified by the proving entity. The brokering service provides the digitally verifiable proof to the requesting device, wherein the digitally verifiable proof causes the requesting device to display an indication that the online claim has been securely verified.

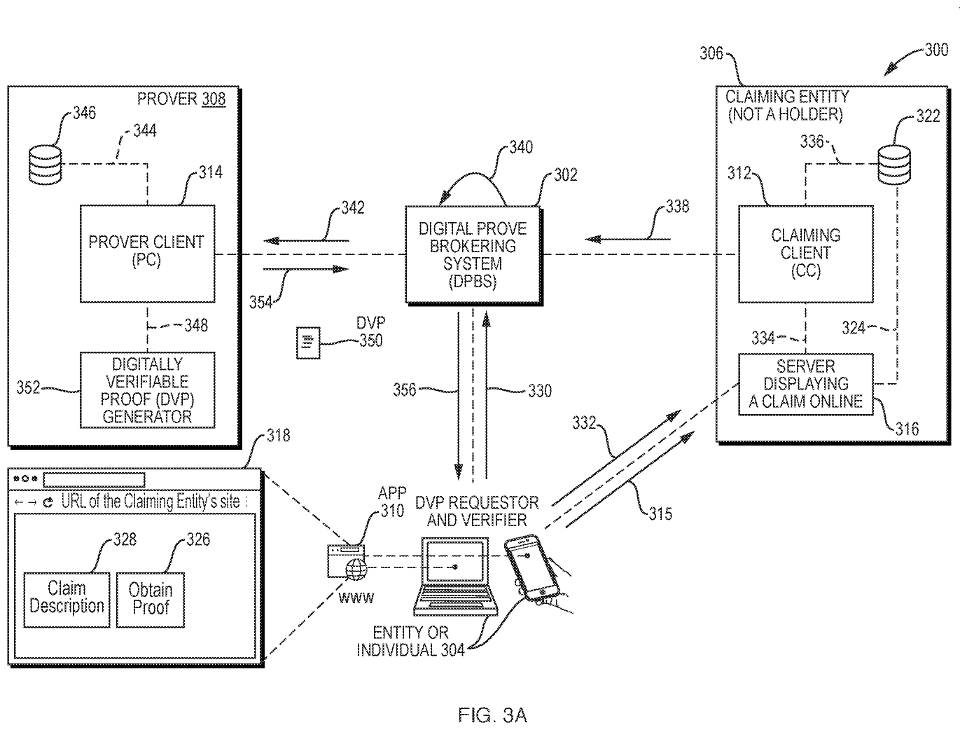

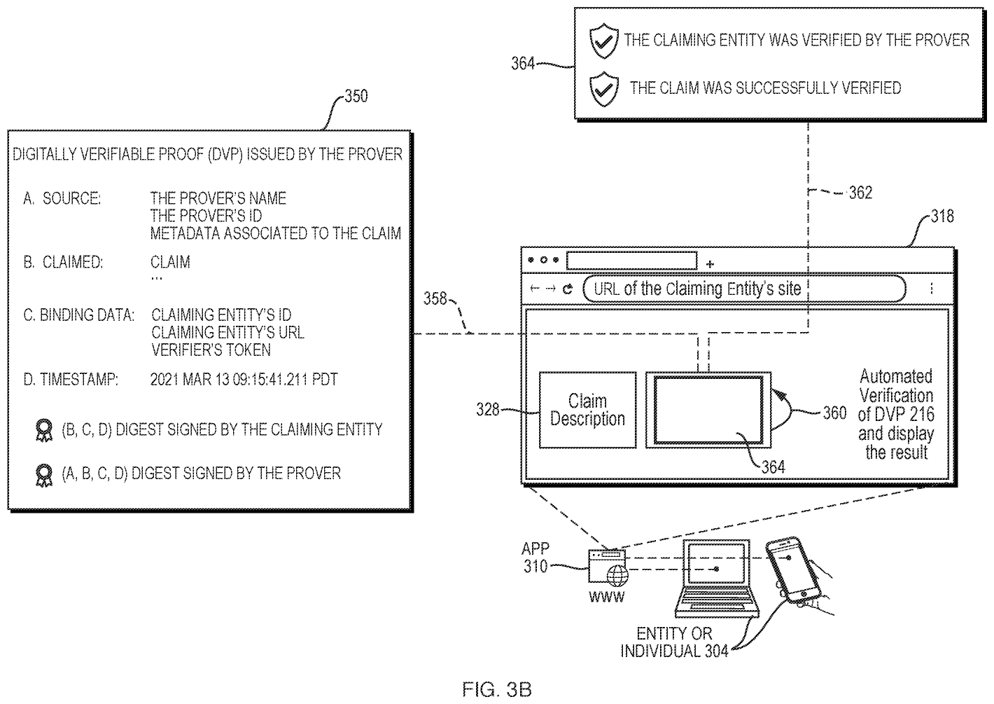

Operationally, FIGS. 3A-3B illustrates an example architecture 300 of a brokering service 302 being used to verify an online claim, according to various embodiments. The architecture 300 may comprise an end user verifier device 304, a claiming entity 306, and a prover organization (or entity) 308. The brokering service 302 (e.g., a digital prove brokering system (DBPS)) may communicate and interface with each of end user verifier device 304, claiming entity 306, and prover organization 308. It is to be understood that the brokering service 302 may be in communication and with interface with a plurality of each of these devices, entities, or organizations 304-308. Further, brokering service 302 may be implemented in a distributed fashion (e.g., across a plurality of networking environments) and might provide services across different geographical regions. In the example architecture 300 shown, a claim that is stored on the claiming entity 306 and ultimately displayed at the end user verifier device 304 may be verified using the brokering service 302. Brokering service 302 has the ability to verify the claim because it is in communication with the prover organization 308 and is configured as described with respect to the techniques described herein.

As shown, an end user at the end user verifier device 304 (that may comprise a general purpose computing device, mobile device, etc.) may utilize the end user verifier device 304 to browse online resources, websites, etc. by using an application 310 (e.g., a web browser) 310. Application 310, by supporting internet communication protocols found in the art, may exchange data that to browse the web (i.e., the Internet) and select web pages displaying claims online or assertions by claiming entity 306. Application 310 may be configured to request, process, and verify the proofs issued by the corresponding provers, for example, prover organization 308, and forwarded by brokering service 302. It is to be understood that application 310 may be implemented in a variety of fashions, as understood in the art, for example, it may run partially or entirely on mobile phones, tablets, laptops, desktop PCs, computer blades in a datacenter, etc. For instance, application 310 may be implemented: a) in the form of a “white label” application with in-app browsing capability, thereby allowing an end user at end user verifier device 304 to browse the Internet (including a website or online resource provided by claiming entity 306) and automatically request, process, and verify proofs from different provers (e.g., prover organization 308) through application 310; b) as a web browser that natively embeds the functionality required to automatically request, process, and verify the proofs issued by the corresponding provers; c) a plugin extension that may run on existing web browsers or as an application that may interact with them; or d) purpose-specific application that is compatible with end user verifier device 304, which may be built upon a software development kit (SDK) to support the automated processing and verification of proofs (from prover organization 308).

Claiming entity 306 comprises an online resource as well as any computer hardware software that may be configured to host online claims or assertions made by claiming entity 306 that may be verified using brokering service 302. For example, claiming entity 306 may be an online retailer that has a claim about authenticity of a good, a service provider that has an assertion about the quality of its service, etc. Prover organization 308 represents an entity or organization, which according to the disclosure herein, has the capacity to prove an online claim or assertion that is hosted on the website or online resource hosted by claiming entity 306. For example, prover organization 308 may comprise an actual manufacture of a good sold by claiming entity 306, a standards organization than attest to the service provided by claiming entity 306, etc. As will be described in greater detail below, such claims or assertions is the object of the proof that indicates the veracity of a claim or assertion of claiming entity 306.

It is contemplated that claiming entity 306 and prover organization 308, according to the techniques described herein, may need to register with brokering service 302 to make use of online claim verification services described herein. For instance, this may allow them to obtain a unique identifier within brokering service 302; allow for dynamic discovery of claiming client software and/or modules 312 and prover client software and/or modules 314; maintain secure communications with brokering service 302; and support the use of application program interfaces (APIs) and communication protocols to exchange ephemeral proofs, etc. End user verifier device 304, in lieu of this registration, may rely on application 310 that automatically registers with brokering service 302 upon installation.

Altogether, the brokering service 302 may facilitate the issuance of digitally verifiable proof (DVP), or an ephemeral proof, that may be used by end user verifier device 304 to verify an online claim or assertion displayed at a website or online resource of claiming entity 306 is legitimate. Brokering service 302 may dynamically receive requests (from end user verifier device 304) for verification of a claim and enables the automatic verification of the claims (by prover organization 308). In an example, the verification of an online claim may begin at step 315 when an end user, using application 310 at end user verifier device 304, connects to a web server 316 of claiming entity 306. For example, as shown, the end user at end user verifier device 304, using application 310, may browse various claims or assertions made by claiming entity 306 via a web browser 318. Such claims or assertions may be about the authenticity of a product, certification status of a service, etc.

As an end user at end user verifier device 304 browses through various web pages showing different claims of claiming entity 306, claiming entity 306 may offer the possibility to obtain a verifiable proof for the claims displayed. Such verification might be available only for a subset of the claims displayed by the claiming entity 306. The list of claims for which the claiming entity 306 may offer such possibility may be stored in a data store system 322 of claiming entity 306. Such information might be automatically retrieved, at step 324, from data store system 322, processed by web server web server 316, and displayed in web browser 318 of application 310. In the example shown in FIG. 3A, for instance, a graphical user interface (GUI) may indicate the possibility to obtain a proof for some claims of claiming entity 306 in the form of an “Obtain Proof” button 326. Button 326 may be displayed next to a corresponding claim description 328 (shown in FIG. 3A as “Claim Description”) which describes that nature of a claim or assertion of claiming entity 306. It is to be understood that, data store system 322 is shown as comprising part of claiming entity 306, but other possible embodiments may apply as well. For instance, a list of claims or assertions regarding goods/services for which the claiming entity 306 may offer proofs for may be hosted by brokering service 302, or by prover organization 308.

If the end user at end user verifier device 304 causes an indication that button 326 (indicating a proof for a good or service is desired) has been selected, application 310 may simultaneously cause the following communications: in step 330, a request for a Digitally verifiable proof (DVP) sent to the brokering service 302 and, in step 332, a request to claiming entity 306.

With more particularity regarding the request for a DVP, it may include any or all of the following:
A) A reference to prover organization 308 and to a claim corresponding to claim description 328. The reference may be available to application 310 through data contained in a description that corresponds to button 326. In one embodiment, a data model used for the claim description 328 may be defined by brokering service 302. The data model may include the name or a reference to prover organization 308, the name and type of claim and may also include unique identifiers (IDs) both of prover organization 308 and the corresponding claim within brokering service 302. Application 310 may parse and check the claim description 328 before triggering a DVP request (e.g., such requests may only be generated for complete claim descriptions that adhere to the data model defined by brokering service 302). Hence, the claim description 328 may have a twofold purpose. Firstly, it may allow a human being (e.g., end user at end user verifier device 304) to identify and interpret the claim. Secondly, the data may be formatted and encapsulated in such a way that they can be parsed and processed by application 310 in a secure and automated manner (i.e., without human intervention). Other embodiments may rely on machine readable data models defined by claiming entity 306, prover organization 308, or a third party.
Data models used for claim descriptions should be processable by the application 310 in an automated manner. In one embodiment, the claim description 328 might be obtained by application 310 from web server 316 of claiming entity 306 (e.g., after retrieving, processing and exposing relevant data from data store system 322). In other embodiments, claim description 328 might be received from the system brokering service 302 (e.g., they might be filled in by the prover organization 308 or claiming entity 306 and proxied by brokering service 302). In this regard, the contents displayed in application 310 might come from different sources. That is, the contents might be received from web server 316, from brokering service 302, or from both of them concurrently, and they may be mashed up, combined and overlaid by application 310 in a transparent manner, thereby creating a unified view for the end user at end user verifier device 304. Indeed, the end user might simply view web browser 318 and would not be able to distinguish which data is coming from web server 316 and which is coming from brokering service 302 by mere inspection of application 310.
B) A reference to claiming entity 306. This may include a uniform resource locator (URL), uniform resource identifier (URI), etc. of claiming entity 306 and a public IP address, which may be temporarily stored, parsed, and handled automatically by application 310.
C) A verifier token. This may represent an alphanumeric string that may act as a one-time session identifier associated to the DVP request and may be randomly generated by application 310. For instance, by selecting a nonce and hashing it together with some of the contents above described, such as the claim description 328. Different mechanisms may be used to reduce dramatically the probability of token collisions in brokering service 302. In some embodiments, end user verifier device 304 may not require any credentials to access the brokering service 302. That is, application 310 may handle the tokens and secure the communications with brokering service 302 natively, while preserving the anonymity and privacy of end user verifier device 304. Other embodiments may leave this as optional. For instance, an end user verifier device 304 that might be willing to engage with “preferred” proving entities (e.g., prover organization 308), it may register with brokering service 302 by creating a user account, selecting a password, and defining a specific engagement policy with the “preferred” proving entities.
D) A timestamp. This may indicate when the request for a DVP is generated by, for example, application 310.

Brokering service 302 may receive the request for a DVP (comprising the aforementioned elements) from application 310. The request for a DVP may be temporarily persisted by brokering service 302 until it can be bond to a message received from claiming entity 306 (as will be described in greater detail herein below) or a configurable timeout is reached. Hence, a request for issuing a proof may be sent to prover organization 308, if, and only if, brokering service 302 can successfully parse and bind a message received from end user verifier device 304 with one received from claiming entity 306 within a time window. It is to be understood, as described in greater detail herein, this would enable a multi-factor verification (MFV) process performed in concert between brokering service 302 and prover organization 308 before issuing a DVP.

At step 332, application 310 may communicate a request to claiming entity 306 that may comprise: A) a reference to prover organization 308 and to a claim corresponding to claim description 328, B) a verifier token; and C) a timestamp. It is to be understood that the exact (or substantially the) same data segments were sent to brokering service 302 in step 330. As will be described in greater detail herein below, these data may be combined with complementary information supplied by claiming entity 306, which may be assembled and subsequently sent to brokering service 302. Such data supplied by the claiming entity 306 may enable brokering service 302 and prover organization 308 to perform the aforementioned MFV process.

At step 334, the request to claiming entity 306 from step 332 (sent by application 310) may be received by web server 316 and forwarded to the claiming client software and/or modules 312 of claiming entity 306. At step 336, claiming client software and/or modules 312 may use prover organization 308 and claim references received from step 334 as inputs and retrieve data from data store system 322. The data obtained may include an ID of claiming entity 306 of brokering service 302 and may also include metadata about the claim (e.g., a region for which the claim is made). Hence, the additional data obtained by claiming client software and/or modules 312 from data store system 322 may be integrated by claiming entity 306, which could be verified by brokering service 302 and prover organization 308.

At step 338, information received from step 332 and forwarded to claiming client software and/or modules 312 in step 334 may then be combined with the data retrieved from data store system 322 in step 336, may be assembled and sent by claiming entity 306 to brokering service 302. More specifically, the original data segments in steps 332, 334, and 336 may be combined with metadata added by claiming entity 306. Moreover, the data sent to brokering service 302 may be digitally signed by claiming entity 306. This may be implemented by an auxiliary system accessible from claiming client software and/or modules 312 or by the client itself.

At step 340, brokering service 302 may perform a multi-factor verification process of the above-described request by, firstly, parsing the message received from claiming entity 306 and obtaining a verifier token contained in. Brokering service 302 may use such token as a key to perform an internal lookup process to find a temporarily persisted message with a matching key (e.g., one that has not yet reached the timeout limit). If the brokering service 302 finds a matching entry, then it may proceed to compare the data received from application 310 in step 330 with the one received from claiming client software and/or modules 312 in step 338. For instance, while application 310 might have sent a URI of claiming entity 306 and its public IP address, claiming client software and/or modules 312 might have sent an ID if claiming entity 306 that is used by brokering service 302. Brokering service 302 may rely on internal or external means to correlate such information and make a determination as to whether they are associated to the same (e.g., a registered) claiming entity 306. Notably, brokering service 302 may provide storage resources and policy definition capabilities, such that prover organization 308 may configure and control a list of claiming entities and specific claims for which it is configured to issue a DVP. As part of such information, prover organization 308 may provide, among other data, the name and URL(s) associated to claiming entities for which it may issue DVPs, such as claiming entity 306. Brokering service 302 may then assign an ID to claiming entity 306, which might be stored internally along with other information regarding claiming entity 306. In another embodiment, claiming entity 306 may provide the other information, where such information may be verified by prover organization 308 prior to brokering service 302 assigning an internal ID (used in brokering service 302). If all the data segments received in step 330 match those received in step 338, then brokering service 302 may forward the DVP request to prover organization 308. If there is an explicit mismatch in the data, however, brokering service 302 may be configured to not forward the DVP request to prover organization 308, thereby rejecting the request.

In step 342, if the above-described multi-factor verification process performed in step 340 is deemed successful, brokering service 302 may identify the corresponding prover, as show, prover organization 308, and may send a DVP request to prover client software and/or modules 314 of prover organization 308. Brokering service 302 generally may be configured to check and reject requests based on data mismatches. It is contemplated that prover client software and/or modules 314 of prover organization 308 may perform additional verification, authentication, etc. steps regarding analysis of request(s) and decisions as to whether there is permission regarding the issuance of DVPs (for corresponding requests(s)).

In step 344, after obtaining the DVP request, prover client software and/or modules 314 of prover organization 308 may access a prover verification and authentication system 346 that comprises processes for determining whether to issue DVPs for a particular DVP request. Notably, prover verification and authentication system 346 may comprise policies, heuristics, etc. that govern whether a DVP may be issued based on, for example, data included the obtained DVP request. Particularly, prover organization 308 may parse data in the DVP request and use prover verification and authentication system 346 to check if a policy allows for issuing a DVP for a corresponding claim (indicated by the DVP request). While, the example shown in FIG. 3A, shows prover verification and authentication system 346 as functionally part of prover organization 308, other embodiments are contemplated. For instance, a list of claiming entities as well as online claims associated to them may be stored in the system prover verification and authentication system 346, which may be hosted at brokering service 302 (instead of by prover organization 308). Indeed, brokering service 302 may enable coordination and data synchronization between data store system 322 and prover verification and authentication system 346. Such coordination may be implemented in different ways, including centralized or distributed instances managed and synchronized through brokering service 302, push/pull data mechanisms, etc.

At step 348, if prover client software and/or modules 314 finds a matching policy (by utilizing prover verification and authentication system 346) then prover organization 308 may proceed to generating a DVP 350. As shown, this may be performed by a digitally veritable proof (DVP) generator 352 that produces a machine-readable proof. Such DVP may be processed and securely verified by application 310 in an automated manner. It is contemplated that the DVP 350 is ephemeral in nature and may combine data received in step 342 with specific, supplementary data from prover organization 308, bound to the claiming entity 306. The DVP 350 may include data digitally signed by claiming client software and/or modules 312 in step 338 as well as appended with data provided by the prover organization 308. The DVP 350 may, in turn, be digitally signed prover organization 308. It is contemplated that such forward signing process may be carried out by proof generator 352.

At step 354, prover client software and/or modules 314 of prover organization 308 may transmit DVP 350 to brokering service 302. At step 356, brokering service 302 may serve as a proxy for communication of the DVP 350 and forward DVP 350 to the application 310. To this end, a verifier token (as described herein above) may be used again as a key, to retrieve a corresponding destination address. Various embodiments may be used to make the DVP 350 available to application 310. For instance, application 310 may open a session in step 330 and wait until brokering service 302 responds with DVP 350, a denial message, or an error message. Other embodiments may rely on stateless APIs and communications, where the data might be either pulled from or pushed to application 310. Once a response is sent back to application 310, any data associated with verification of the above claim or assertion that is temporarily persisted by brokering service 302 may be flushed. It is to be understood that the above-described steps regarding generation and delivery of DVP 350 do not involve claiming entity 306 in that the DVP 350 never transits through infrastructure of claiming entity 306. At step 356, brokering service 302 may transmit DVP 350 to end user verifier device 304.

In an alternative embodiment, the proving entity 308 may define one or more policies, beforehand, that are to be stored in the brokering service 302, thereby delegating the generation and issuing of DVPs, if and only if, they match a defined policy. In such a case, the DVPs might be generated and issued by the brokering service 302 directly.

Turning now to FIG. 3B, more detail regarding information that may be displayed at an end user verifier device 304 is shown, after the end user verifier device 304 obtains the DVP 350. In particular, application 310 may automatically verify by parsing DVP 350 (for example, due to the how DVP 350 is formatted and encoded). In particular, application 310 may parse contents of DVP 350, as shown in FIG. 3B. The contents of DVP 350 may include:
A) A segment that may contain data coming from a source of DVP 350 (e.g., directly from prover organization 308), which may include a name of prover organization 308, an ID of prover organization 308 used in brokering service 302, and additional metadata (e.g., the region/country where DVP 350 applies).
B) A segment that may detail claim description as it was sent by application 310 in step 330, reasserted by claiming entity 306 in step 338, verified by brokering service 302 in step 340, and legitimated and proved by prover organization 308 in step 344 and step 348. Issuance of DVP 350 may itself indicate that its included claim may be in compliance with policy defined by prover organization 308 (as stored in prover verification and authentication system 346).
C) A segment that may bind an identifier of claiming entity 306 in brokering service 302 to a URL, URI, etc. of claiming entity 306 and a verifier token, as they were transmitted by application 310 in step 330.
D) A segment that may contain the timestamp sent by application 310 both to brokering service 302 in step 330 and to the claiming entity 306 in step 332.

As shown in FIG. 3B, the data segments B, C, and D may be signed by the claiming entity 306, since all these data segments may be available to claiming entity 306. In turn, data segments A, B, C, and D may be signed by prover organization 308.

At step 358, application 310 may parse received DVP 350. At step 360, subsequent to parsing DVP 350, application 310 may proceed to automatically verifying DVP 350. To this end, application 310 may identify and compare the data segments sent to brokering service 302 in step 330 with those received in DVP 350. For instance, application 310 may compare: i) an identifier of prover organization 308 and a claim (or assertion) sent; ii) an identifier of claiming entity 306 and a URI, URL, etc. of claiming entity 306; iii) a verifier token (used for requesting DVP 350); and a timestamp sent. Application 310 may have or request access to public keys of both claiming entity 306 and prover organization 308 from brokering service 302. Other embodiments are contemplated. For instance, quantum-resistant algorithms and mechanisms might be applied in the selection and/or the exchange of the public keys.

At step 362, once the automated verification process is completed, the end user verifier device 304 may be configured to present the result in a human readable form. In one embodiment, shown in FIG. 3B, results 364 of the verification might be overlaid where button 326 was once shown. For instance, if the verification process is deemed successful, then results 364 may display the outcome shown in FIG. 3B both for the claiming entity 306 and a claim itself, which indicates that claiming entity 306 is a “trusted” claimant and a particular claim of it has been verified by prover organization 308. It is contemplated that digital proof and verification can be handled by brokering service 302 in a secure and automated manner (e.g., without any human intervention in the “background”) without needing to display results 364 in a human readable manner.

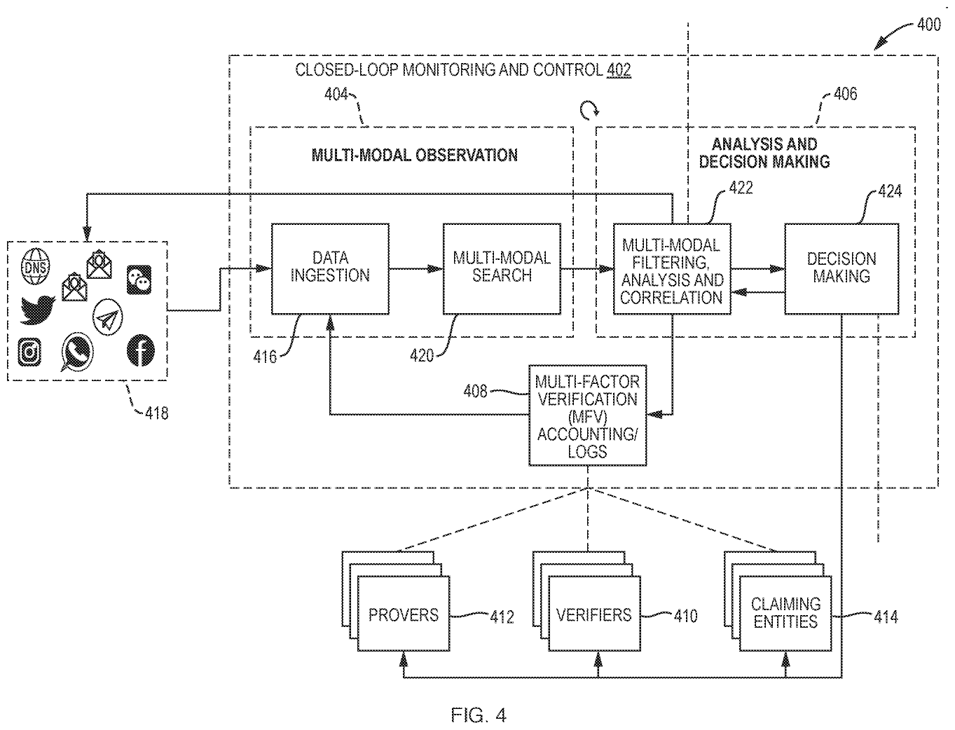

With reference now to FIG. 4, an example architecture 400 of a proactive proving monitoring system 402 (that implements proactive proving monitoring process 249) for discovery of online claims that may be implemented in conjunction with digital proving brokering process 248 is shown. In particular, proactive proving monitoring system 402 may enable organizations, entities, etc. to discover, monitor, filter, analyze and act on claims found online that are relevant to them (e.g., using the above-described claim verification techniques described above). In particular, proactive proving monitoring system 402 may comprise a multi-modal observation module 404, an analysis and decision making module 406, and a monitoring module 408 that is associated with the MFV process described above (e.g., in the form of an accounting database and/or log files). Each of these components 404-408 work in concert, thereby offering closed-loop monitoring and control for relevant claims found online.

Monitoring module 408 may gather data involving verifiers 410 (e.g. a plurality of end user verifier device 304), provers 412 (e.g., a plurality prover organization 308), and claiming entities 414 (e.g., a plurality of claiming entity 306). Such data may include logs with successful and unsuccessful requests of DVPs from the verifiers 410 (e.g., exposing rejections that did not pass the MFV process performed by brokering service 302), successful and unsuccessful generation and delivery of DVPs to verifiers 410, etc. The data gathered by monitoring module may be used as input to a data ingestion module 416 of multi-modal observation module 404.

Additional data sources may be used to expand the reach and search for relevant claims online for use by data ingestion module 416. As shown in FIG. 4, multi-modal observation module 404 may be configured to gather data from a variety of different data sources 418, including email security tools, email spam tools, social media, and from DNS lookups (e.g., using tools such as Cisco Umbrella™). Currently, tools based on DNS lookups generally leverage the domain name resolution to discover online sites and search for traditional security threats in their contents, such as malware, ransomware, etc. Instead of searching for security threats, multi-modal observation module 404 may search for unverifiable claims that might represent a different type of risk to an organization or to the individuals and/or entities that it may represent. For instance, a public entity may discover sites claiming that the food they supply within their area of authority is “bio”, even though there are no records allowing the claiming entities to catalog their supplies as “bio”. Similarly, an organization such as ISO may discover sites claiming ISO certifications that they do not have.

Data gathered by data ingestion module 416 may be used by a multi-modal search module 420 that subjects the data to programmable searches of different types, nature, etc. The outcome of these searches may be filtered, analyzed, and correlated by a multi-modal filtering, analysis, and correlation module 422 of analysis and decision making module 406. Multi-modal filtering, analysis, and correlation module 422 may perform searches, analysis, processes, etc. that discovers new insights regarding claims (or assertions) made by claiming entities and may trigger new (more targeted) searches (e.g., on known claiming entities, social media, newly discovered web sites, etc.).

Analyses performed by multi-modal filtering, analysis, and correlation module 422 may entail decision making and acting. For instance, discoveries that are relevant for an organization (e.g., a prover organization 308) may be made available to the organization through a decision making module 424 of an analysis and decision making module 406. Decision making module 424 may be configured to generate and transmit specific alerts to the organization upon discovery of relevant claims. For instance, if proactive proving monitoring system 402 discovers that a claiming entity is selectively displaying claims online, some of which are verifiable, whereas others seem to be intentionally unverifiable, decision making module 424 may raise an alarm to corresponding prover(s). Depending on the risk and severity of the findings, the decision making module 424 may instruct a proving entity (e.g., prover organization 308) to disable generation of DVPs for a given claiming entity (e.g., claiming entity 306), or even block further requests received from them. Another type of alarm may lead the proving entity to take action against claims found in social media or other online sites.

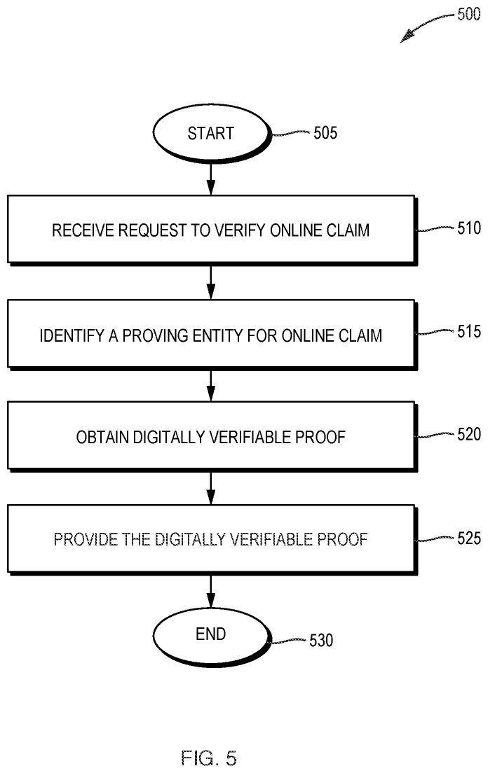

FIG. 5 illustrates an example simplified procedure (e.g., a method) for verifying online claims by a brokering service, in accordance with one or more embodiments described herein. For example, a non-generic, specifically configured device (e.g., device 200), may perform procedure 500 by executing stored instructions (e.g., digital proving brokering process 248 and/or proactive proving monitoring process 249). The procedure 500 may start at step 505, and continues to step 510, where, as described in greater detail above, a brokering service at the device may receive, from a requesting device, a request to verify an online claim associated with an online resource. For instance, the request may be to verify and/or authenticate the veracity of a claim or assertion made on a claiming entity's website, as described in greater detail herein above. The claim or assertion may be an indication of quality, provenance, source, etc. of a good or service. It may, alternatively, indicate whether a good or service is incompliance with an organization. In some embodiments, the request to verify the online claim conforms with a data model defined by the brokering service.

At step 515, as detailed above, the brokering service may identify, based upon the request, a proving entity for the online claim. In some embodiments, the brokering service may perform, based upon the request, a multi-factor verification process prior to identifying the proving entity. In particular, when the request comprises a verifier token that acts as a one-time session identifier associated with the request, the brokering service may determine whether a proving organization and a claiming organization have registered to issue digitally verifiable proof regarding one or more claims or assertions.

At step 520, the brokering service may obtain, from the proving entity, digitally verifiable proof that indicates that the online claim has been securely verified by the proving entity. In an embodiment, the digitally verifiable proof may be signed by both the proving entity and a claiming entity associated with the online claim. Of note, the claiming entity may not itself have access to the digitally verifiable proof. Further, the claiming entity may store the online claim in a list of online claims from which the requesting device can request digitally verifiable proof. In some embodiments, the digitally verifiable proof may be generated by the brokering service (where it has been configured in a manner to handle one or more functions of the above described proving entity).

At step 525, as detailed above, the brokering service may provide, the digitally verifiable proof to the requesting device, wherein the digitally verifiable proof may cause the requesting device to display an indication that the online claim has been securely verified, as described in greater detail above. In an embodiment, the digitally verifiable proof is encrypted using public keys provided by the proving entity and the claiming entity, where the requesting device may decrypt the digitally verifiable proof using the public keys. Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce a mechanism to ensure the veracity, authenticity, etc. of online claims or assertions that may be made by claiming entities using a brokering service to verify the online claims. Doing so can help to prevent users from having to merely rely on their eyes when coming across logos, indicators, etc. that may be easily co-opted my malicious actors. Further, the mechanism does neither need nor depend on blockchain-based solutions that offer a plurality of technical problems as well as issues with “trust”.

While there have been shown and described illustrative embodiments that provide verifying online claims by a brokering service, it is to be understood that various other adaptations and modifications may be made within the spirit and scope of the embodiments herein. For example, while certain embodiments are described herein with respect to using the techniques herein for certain purposes, the techniques herein may be applicable to any number of other use cases, as well. In addition, while certain types of online claims or assertions are discussed herein, the techniques herein may be used in conjunction with any online claims or assertions.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving, at a brokering service and from a requesting device, a request to verify an online claim associated with an online resource;
identifying, by the brokering service and based upon the request, a proving entity for the online claim;
obtaining, by the brokering service and from the proving entity, digitally verifiable proof that indicates that the online claim has been securely verified by the proving entity; and
providing, by the brokering service, the digitally verifiable proof to the requesting device, wherein the digitally verifiable proof causes the requesting device to display an indication that the online claim has been securely verified.

2. The method as in claim 1, wherein the request to verify the online claim conforms with a data model defined by the brokering service.

3. The method as in claim 1, wherein the proving entity determines whether to issue digitally verifiable proof based on a policy.

4. The method as in claim 1, further comprising:
performing, by the brokering service and based upon the request, a multi-factor verification process prior to identifying the proving entity.

5. The method as in claim 4, wherein the request comprises a verifier token that acts as a one-time session identifier associated with the request.

6. The method as in claim 1, wherein the digitally verifiable proof is signed by both the proving entity and a claiming entity associated with the online claim.

7. The method as in claim 6, wherein the claiming entity does not have access to the digitally verifiable proof.

8. The method as in claim 6, wherein the claiming entity stores the online claim in a list of online claims from which the requesting device can request digitally verifiable proof.

9. The method as in claim 6, wherein the digitally verifiable proof is encrypted using public keys provided by the proving entity and the claiming entity.

10. The method as in claim 1, further comprising:
obtaining, by the brokering service, an indication of the online claim from a proactive proving monitoring process.

11. An apparatus, comprising:
one or more network interfaces;
a processor coupled to the one or more network interfaces and configured to execute one or more processes; and
a memory configured to store a process that is executable by the processor, the process when executed configured to:
receive, from a requesting device, a request to verify an online claim associated with an online resource;
identify, based upon the request, a proving entity for the online claim;
obtain, from the proving entity, digitally verifiable proof that indicates that the online claim has been securely verified by the proving entity; and
provide the digitally verifiable proof to the requesting device, wherein the digitally verifiable proof causes the requesting device to display an indication that the online claim has been securely verified.

12. The apparatus as in claim 11, wherein the request to verify the online claim conforms with a data model defined a brokering service of the apparatus.

13. The apparatus as in claim 11, wherein the proving entity determines whether to issue digitally verifiable proof based on a policy.

14. The apparatus as in claim 11, wherein the process when executed is further configured to:
perform, based upon the request, a multi-factor verification process prior to identifying of the proving entity.

15. The apparatus as in claim 14, wherein the request comprises a verifier token that acts as a one-time session identifier associated with the request.

16. The apparatus as in claim 11, wherein the digitally verifiable proof is signed by both the proving entity and a claiming entity associated with the online claim.

17. The apparatus as in claim 16, wherein the claiming entity does not have access to the digitally verifiable proof.

18. The apparatus as in claim 16, wherein the claiming entity stores the online claim in a list of online claims from which the requesting device can request digitally verifiable proof.

19. The apparatus as in claim 16, wherein the digitally verifiable proof is encrypted using public keys provided by the proving entity and the claiming entity.

20. A tangible, non-transitory, computer-readable medium storing program instructions that cause a brokering service to execute a process comprising:
receiving, at the brokering service and from a requesting device, a request to verify an online claim associated with an online resource;
identifying, by the brokering service and based upon the request, a proving entity for the online claim;
obtaining, by the brokering service and from the proving entity, digitally verifiable proof that indicates that the online claim has been securely verified by the proving entity; and
providing, by the brokering service, the digitally verifiable proof to the requesting device, wherein the digitally verifiable proof causes the requesting device to display an indication that the online claim has been securely verified.
